(19) United States
(12) Patent Application Publication
(10) Pub. No.: US 2015/0003045 A1
(43) Pub. Date: Jan. 1, 2015

(54) WIDE-ANGLE LIGHTING DISPLAY AND PROJECTION DEVICE

(71) Applicant: SU-FANG HO, NEW TAIPEI CITY 236 (TW)

(72) Inventor: SU-FANG HO, NEW TAIPEI CITY 236 (TW)

(21) Appl. No.: 14/488,485

(22) Filed: Sep. 17, 2014

Related U.S. Application Data
(63) Continuation-in-part of application No. 13/535,559, filed on Jun. 28, 2012.

(51) Int. Cl. F21S 10/00

(52) U.S. Cl. CPC F21S 10/002; F21W 2121/00
USPC 362/101

(57) ABSTRACT

A wide-angle lighting display and projection device with the features of its original patent application, displays an unlimited extension of an inward serial arrangement of a transparent bottle from the middle, and further displays special visual effects of lighting and projection of the moving shadows on both sides of the present invention, widening the visual angle and enriching the visual effects of each side thereof.

This patent application is a continuation-in-part of Ser. No. 13/535,559 filed on Jun. 28, 2012, currently pending.

### BACKGROUND OF THE INVENTION

1. Field of the Invention

The present invention relates to a wide-angle lighting display and projection device, particularly to one that not only has features improved from the ones of the original patent application but can further display special visual effects of lighting and projection of the moving shadows on both sides thereof.

2. Description of the Related Art

A lava lamp display device 80 disclosed in U.S. Pat. No. 3,570,156 comprises a glass vessel 81 having a bottom 82 arranged in a hollow conical metallic seating 83 and located on an electric light bulb 84. Moreover, the glass vessel 81 has two immiscible components, for example, liquid 85 and a paraffin 86 which has a high density than the liquid 85 at room temperature and a lower density than the liquid 85 after heating. After the electric light bulb 84 is turned on, the paraffin 86 at the bottom 82 of the glass vessel 81 is heated and flows in the liquid 85. At the same time, the electric light bulb 84 projects the light to the glass vessel 81, forming a lighting effect which becomes a decoration at homes and offices. In addition, if a plurality of glitters are put together with the liquid 85, the glitters would move and flow with the liquid 85; such application is called a glitter lamp. However, the lava lamp display device 80 or the glitter lamp only has lighting effects in a single glass vessel 81. As a decoration, it seems to be monotonous and lacking of visual effects.

Still, the mentioned original U.S. patent application discloses a permeable vision window in the middle of the front side of the frame to displace the lighting object which forms an unlimited extension of an inward serial arrangement from the middle when the non-parallel reflection surfaces are reflected repeatedly, making the invention as a lamp and decoration with special visual effects. However, the vision window is only a small area at the front side of the lamp, leaving the invention to be improved as well.

### SUMMARY OF THE INVENTION

A primary object of the present invention is to provide a wide-angle lighting display and projection device that displays an unlimited extension of an inward serial arrangement of the transparent bottle from the middle when the non-parallel reflection surfaces are reflected repeatedly, and further displays special visual effects of lighting and projection of the moving shadows on both sides of the present invention, widening the visual angle and enriching the visual effects thereof.

Another object of the present invention is to provide a wide-angle lighting display and projection device that is easy for assembling and maintaining.

To achieve the objects mentioned above, the present invention comprises a frame including a base on which a front frame body and a rear frame body are arranged; a film-coated glass mounted on the front frame body and having the front side with light transmittancy facing towards the front frame body as a window surface and the back side with reflectivity; a mounting seat arranged on the base, between the front frame body and the rear frame body with a positioning hole arranged thereon; a projecting device including at least one projecting light disposed in an engaging room under the positioning hole of the mounting seat with a projecting light source thereof aiming at the positioning hole; a support bracket with the lower end thereof arranged on the base of the frame and a lighting source arranged on the upper end thereof; a transparent bottle filled with a filler of liquids with the bottom thereof being disposed on the positioning hole of the mounting seat and located above the projecting device, corresponding to the height of the window surface; a first reflection mirror and a second reflection mirror fixed on the rear frame body, located behind the transparent bottle and having the reflection surfaces thereof facing forward, and a center thereof serving as a reference to define the first and second reflection minors symmetrically, inclined to form an angle θ between 145° and 175°, so that the window surface would display an unlimited extension of an inward serial arrangement from the middle after the contents of the transparent bottle are reflected repeatedly and cumulatively by the first and second reflection mirrors; a cover plate disposed on the rear frame body, behind the first and second reflection mirrors; and two projecting sheets made of materials that are pervious to light but not transparent, and disposed on both sides of the frame for the transparent bottle to project thereon.

In a preferred embodiment, the projecting device includes a PCB having at least one projecting lamp and one resistor arranged thereon with the projecting lamp including a LED light or a bulb. The base has a power supply disposed inside and connected to the projecting device to supply the electric power. Additionally, the transparent bottle can be a lava lamp or a glitter lamp.

In an applicable embodiment, the bottom of the transparent bottle has its periphery engaging with the positioning hole of the mounting seat by fitting or screwing, and the bottom periphery of the positioning hole has an inner flange thereon. Furthermore, the support bracket is arranged in an L shape and is hollow for the power supply to connect to an electric wire through which to supply the electric power for the lighting source on which a lampshade is covering.

Besides, the first and second mirrors behind the rear frame body form an angle θ and have two symmetrical inclined surfaces to form a pre-determined slope when they are joined together. In addition, the two projecting sheets are disposed on the groove arranged between the front and rear frame body.

In an applicable embodiment, the two projecting sheets are made of materials that are pervious to light but not transparent such as plastic board, paper, clothing, and glass.

As structures disclosed above, the present invention not only has a window surface to enlarge the area of the unlimited extension of an inward serial arrangement of the transparent bottle from the middle; also, it can further display a special visual effect of lighting and projection of the moving shadows on both sides of the present invention, widening the visual angle and enriching the visual effects thereof.

### BRIEF DESCRIPTION OF THE DRAWINGS

FIG. 1 is an exploded view of the present invention viewing from the back at an oblique angle;

FIG. 2 is a perspective view of the present invention viewing from the back at an oblique angle;

FIG. 3 is an exploded view of the present invention viewing from the front at an oblique angle;

FIG. 4 is a perspective view of the present invention viewing from the front at an oblique angle;

FIG. 5 is a sectional view of the present invention viewing from the front;

FIG. 6 is a cross-section view along line 6-6 in FIG. 5;

FIG. 7 is a cross-section view along line 7-7 in FIG. 5;

FIG. 7A is a partially enlarged sectional view of FIG. 7;

FIG. 8 is a practical application view of the present invention viewing from the front; and

FIG. 9 is a practical application view of the present invention viewing from a side.

### DETAILED DESCRIPTION OF THE PREFERRED EMBODIMENT

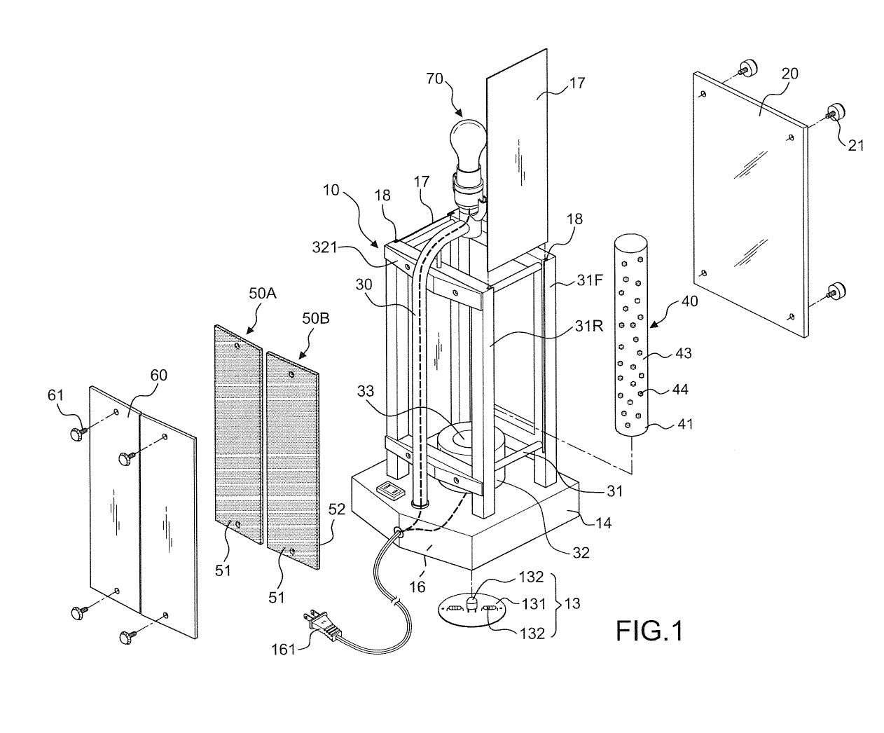

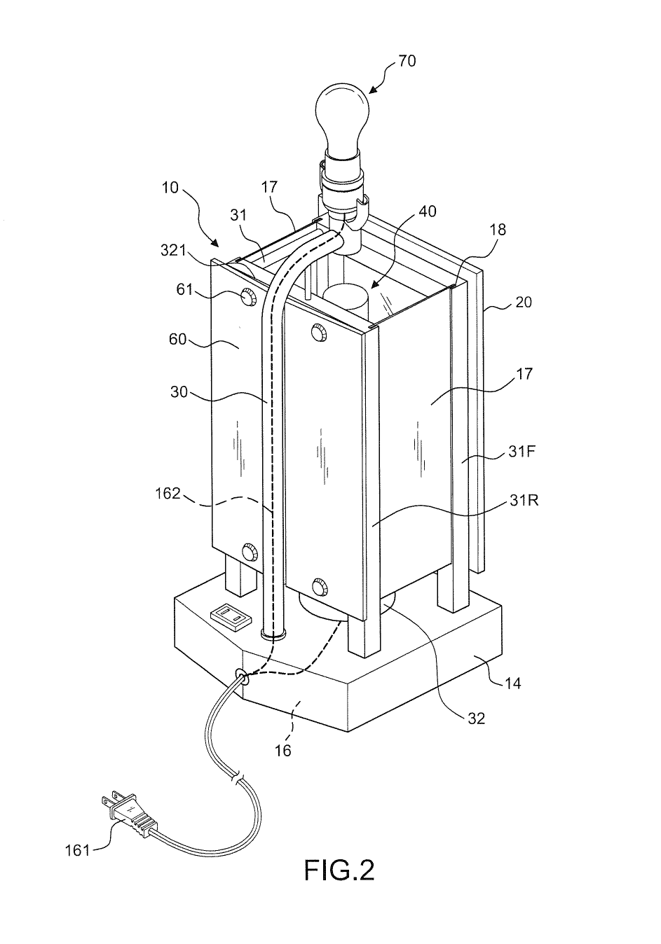

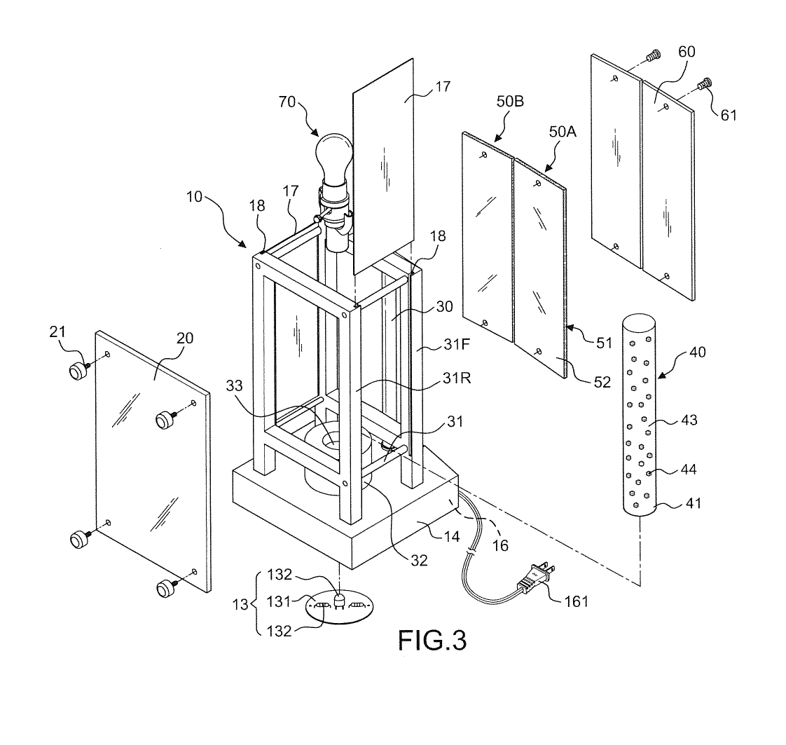

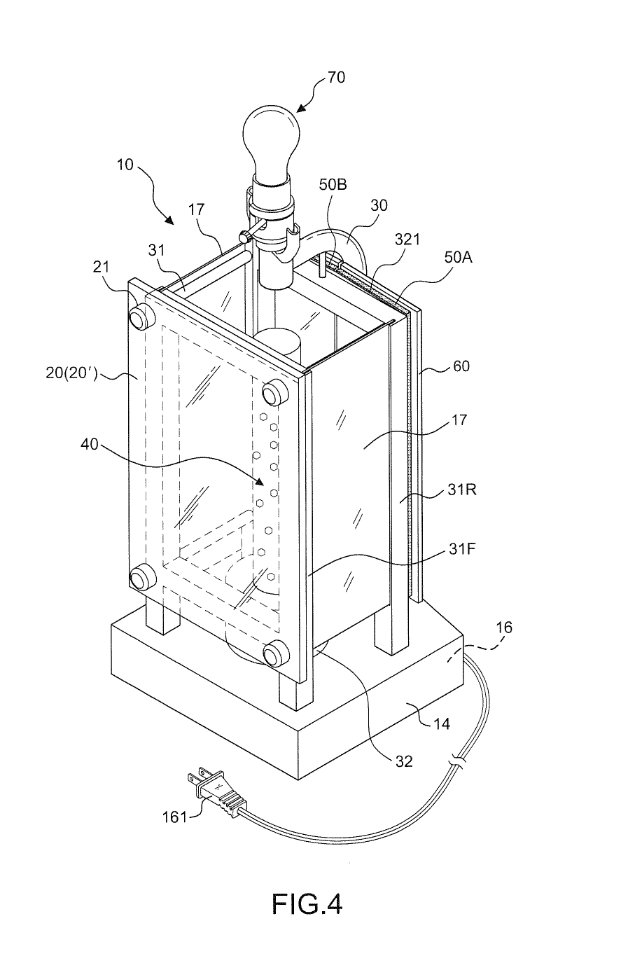

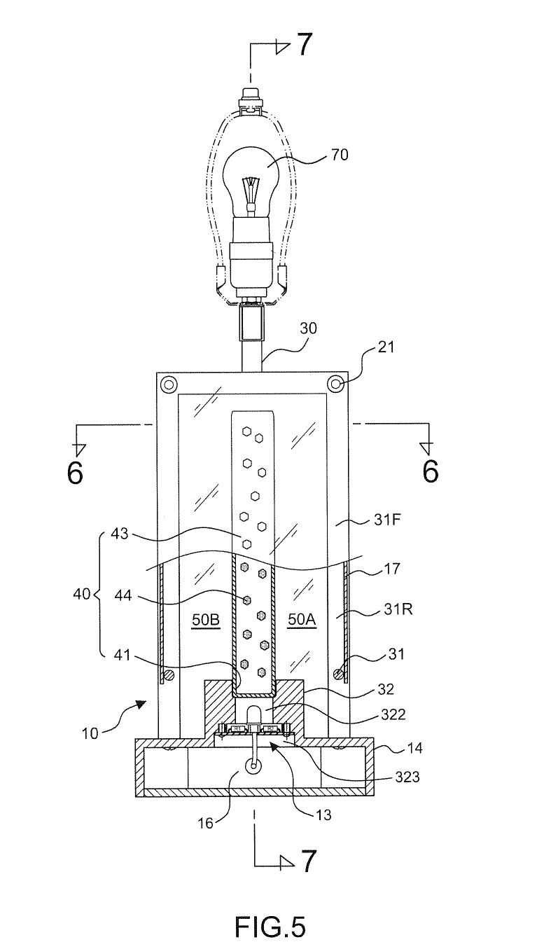

Referring to FIGS. 1-9, in a preferred embodiment, the present invention comprises a frame 10, a film-coated glass 20, a mounting seat 32, a projecting device 13, a support bracket 30, a transparent bottle 40, two projecting sheets 17, a first reflection mirror 50A, a second reflection mirror 50B and a cover plate 60.

The frame 10 includes a base 14 on which a front frame body 31F and a rear frame body 31R are arranged. The front frame body 31F and the rear frame body 31R can be assembled by a plurality of tappets 31 but are not limited to such application.

The film-coated glass 20 is mounted on the front frame body 31F by a positioning element 21 or adhesive substances and has the front side with light transmittancy facing towards the front frame body 31F as a window surface 20′ and the back side with reflectivity; in other words, the visual area of the present invention is not restricted to a small window but a wide area of a window surface 20′.

The mounting seat 32 is arranged on the base 14, between the front frame body 31F and the rear frame body 31R and having a positioning hole 33 arranged thereon. The projecting device 13 is disposed in an engaging room 322 under the positioning hole 33 of the mounting seat 32 with its projecting light source aiming at the positioning hole 33. In this embodiment, the positioning hole 33 and the engaging room 322 are linked up, and the bottom of the engaging room 322 is an opening 323 for the projecting device 13 to be disposed.

The support bracket 30 has its lower end arranged on the base 14 of the frame 10 and its upper end having a lighting source 70 arranged thereon. In this embodiment, the support bracket 30 is arranged in an L shape, but is not limited to such application.

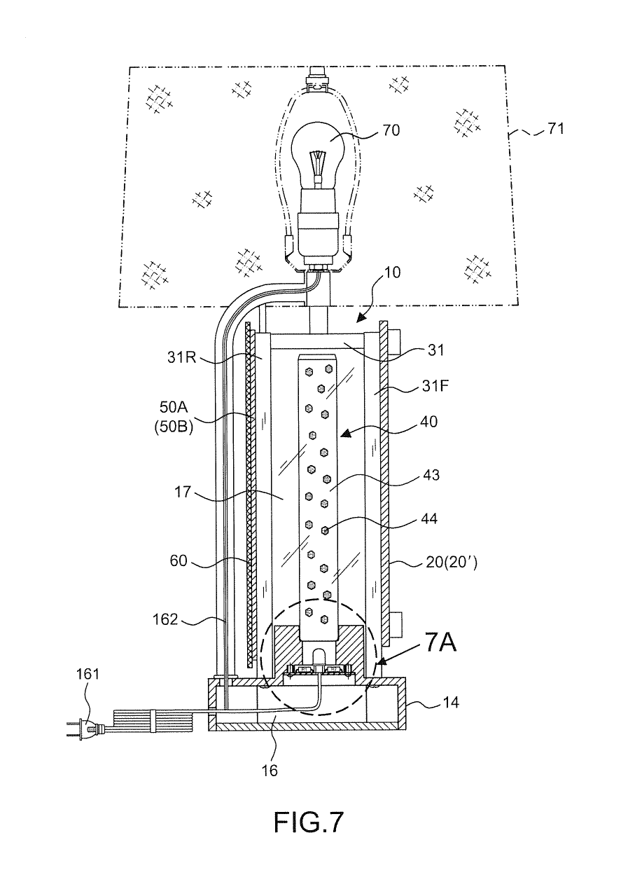

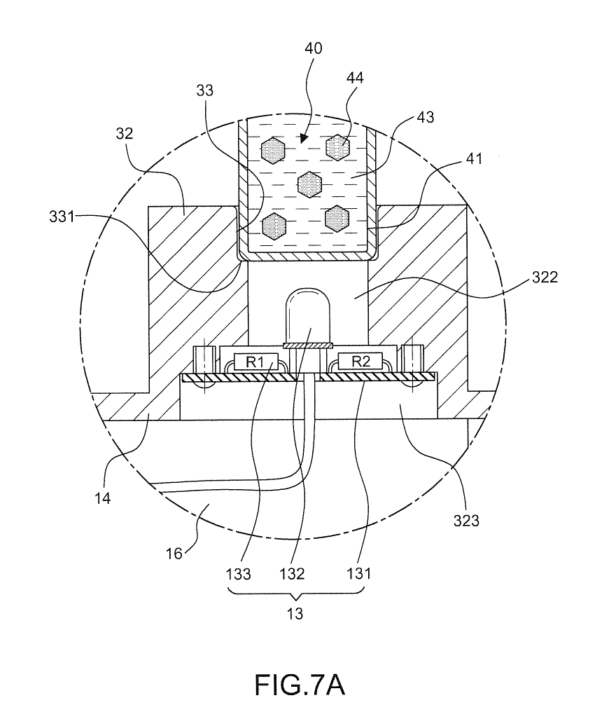

With reference to FIGS. 7 and 7A, the transparent bottle 40 is filled with a filler 43 of liquids with the bottom 41 thereof to be disposed on the positioning hole 33 of the mounting seat 32, and it is vertically located above the projecting device 13, corresponding to the height of the window surface; 20′. In a preferred embodiment, the projecting device 13 includes a PCB 131 having at least one projecting lamp 132 and one resistor 133 arranged thereon with the projecting lamp 132 including a LED light or a bulb, and the base 14 has a power supply 16 disposed inside and connected to the projecting device 13 to supply the electric power. In this embodiment, the transparent bottle 40 can be a lava lamp or a glitter lamp.

The projecting sheets 17 are made of materials that are pervious to light but not transparent, and disposed on both sides of the frame 10 for the transparent bottle 40 to project thereon, whereby the user can enjoy the visual effects showing on the projecting sheets 17 when the lights and moving shadows are projected thereon. In an applicable embodiment, the projecting sheets 17 are made of materials such as plastic board, paper, clothing, and glass. If the projecting sheets 17 are made of transparent materials, the lights and shadows emitted from the transparent bottle 40 would pass through the projecting sheets 17 without any projection thereon; if the projecting sheets 17 are made of opaque materials, the lights and shadows would be kept inside and would not been seen on the projecting sheets 17. In short, only the ones made of materials that are pervious to light but not transparent can display the visual effects of lights and moving shadows.

In a preferred embodiment, the projecting sheets 17 are engaged downwards in a vertical direction on the groove 18 between the front and rear frame body 31F, 31R of the frame 10, allowing the present invention to be easily assembled and maintained; but it is not limited to such application.

In this embodiment, the transparent bottle 40 is a glitter lamp, and the bottom thereof is right above the projecting lamp 132. The glitter lamp can make the filler 43 of liquids inside the transparent bottle 40 flow around at an appropriate degree of temperature. In a preferred embodiment, the projecting device 13 can have a LED light of 5-12 W as the lighting source to make the transparent bottle 40 shine, which is energy saving. When the transparent bottle 40 is too large that the heat produced by the LED projecting light 132 is not enough for the filler 43 of liquids in the transparent bottle 40 to flow around, the resistor 133 disposed on the PCB 131 would provide extra heat energy produced by the currents passing through to make the filler 43 of liquids in the transparent bottle 40 to flow around. Consequently, the projecting device 13 comprising the LED projecting light 132 and at least one resistor 133 is suitable for lighting display device of small sizes. According to the results from practical testing, as long as the transparent bottle 40 has a diameter between 2 to 3.5 cm and a height within 20 cm, the contents inside the transparent bottle 40 would flow around after turning the device on. Therefore, the present invention is also energy saving and has lower percentage of malfunctions.

Since the transparent bottle 40 needs electric power, a power supply 16 can be disposed inside the base 14 to supply the electric power. As presented in FIG. 1, the power supply 16 can be a transformer or an electric supplier disposed inside the base 14; connecting to an external electric wire 161 and an external transformer is also applicable.

The first reflection mirror 50A and a second reflection mirror 50B are fixed on the rear frame body 31R and located behind the transparent bottle 40. The back sides thereof are spread over a layer of reflector 51 and the reflection surfaces 52 thereof are facing forward; a center thereof serves as a reference to define the first and second reflection mirrors 50A, 50B symmetrically, inclined to form an angle θ between 145° and 175°, so that the window surface 20′ would display an unlimited extension of an inward serial arrangement of the transparent bottle 40 from the middle after the contents thereof are reflected repeatedly and cumulatively by the first and second reflection mirrors 50A, 50B; the cover plate 60 is disposed on the rear frame body 31R behind the first and second reflection mirrors 50A, 50B. In this embodiment, the cover plate 60 is fixed on the inclined faces 321 of the rear frame body 31R together with the first and second reflection mirrors 50A, 50B by a plurality of positioning elements 61. The cover plate 60 functions as a protection for the first and second reflection mirrors 50A, 50B. The surface area of the cover plate 60 is larger than the ones of the first and second reflection mirrors 50A, 50B, so as to protect them from external impacts.

In a preferred embodiment, the bottom 41 of the transparent bottle 40 has its periphery engaging with the positioning hole 33 of the mounting seat 32 by fitting or screwing, and the bottom periphery of the positioning hole 33 has an inner flange 331 for the bottom 41 of the transparent bottle 40 to be disposed thereon. In this embodiment, simply engage the bottom 41 of the transparent bottle 40 into the positioning hole 33, and the depth h would stably fix the transparent bottle 40 into the positioning hole 33. Therefore, the transparent bottle 40 is easy for assembling and maintaining by either fitting or screwing to be fixed thereon.

As presented in FIG. 7, in this embodiment, the support bracket 30 is hollow for the power supply 16 to connect to an electric wire 162 through which to supply the electric power for the lighting source 70 on which a lampshade 71 is covering, making the present invention a lighting fixture.

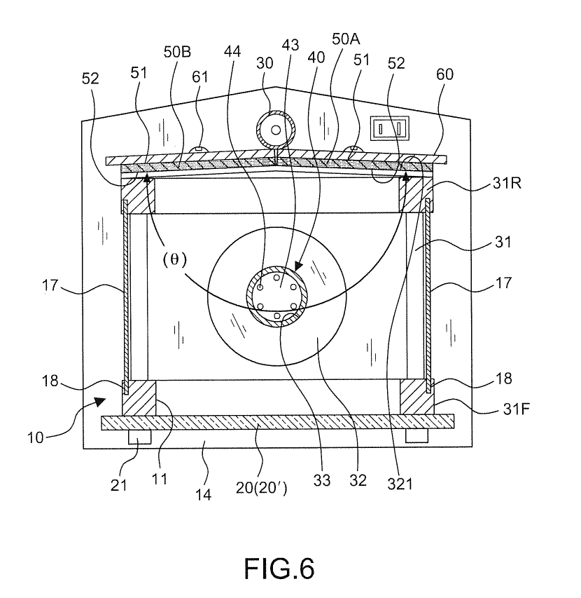

Moreover, referring to FIGS. 1 and 6, the first and second mirrors 50A, 50B behind the rear frame body 31R form an angle θ and have two symmetrical inclined surfaces 131 to form a pre-determined slope when they are joined together. In an applicable embodiment, the angle θ between 145° and 175° is the most preferred angle, repeatedly and cumulatively reflecting at least 6 reflections of the transparent bottle 40 and displaying an extended three-dimensional visual effect.

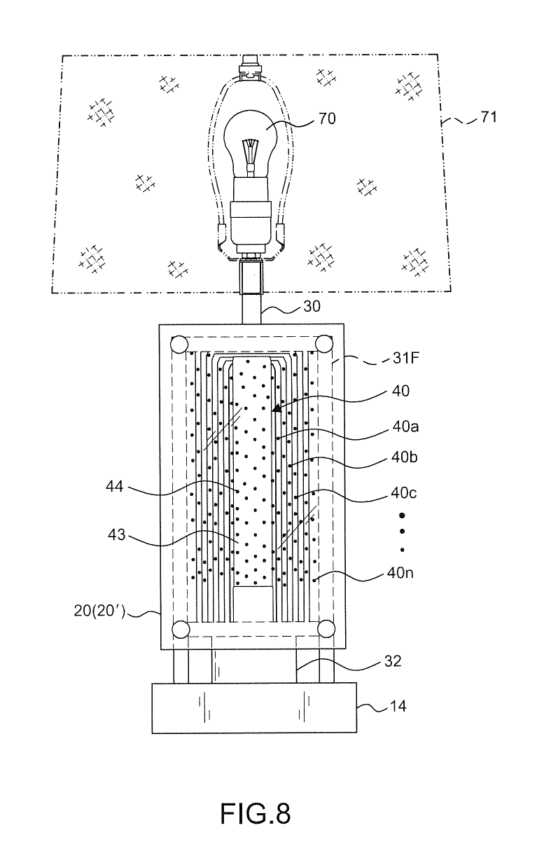

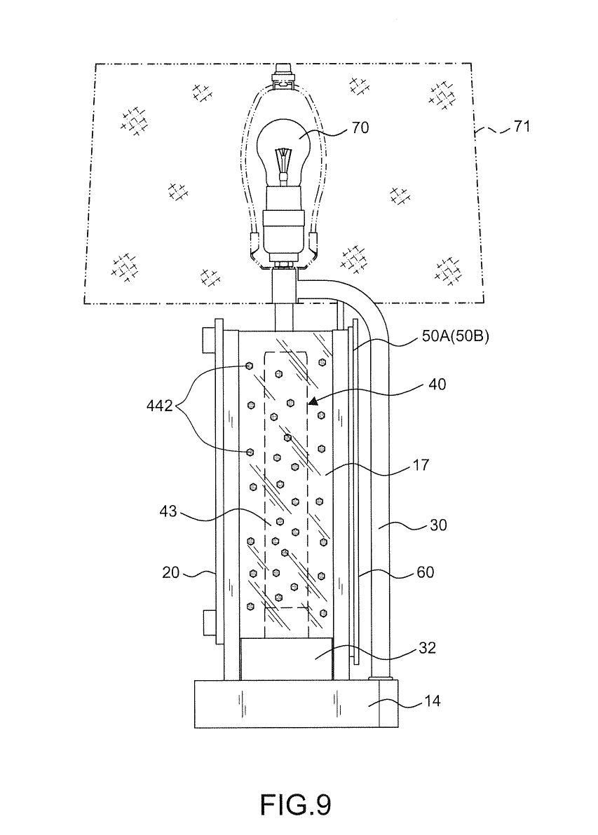

FIG. 8 illustrates the practical applications of the present invention. When the present invention is turned on, the transparent bottle 40 would display visual effects of flowing glitters 44. When the transparent bottle 40 is placed between the film-coated glass 20 and the first and second mirrors 50A, 50B as presented in FIG. 6, the flowing glitters 44 of the single transparent bottle 40 would be reflected repeatedly and cumulatively as shown in FIG. 8, displaying an unlimited extension of an inward serial arrangement from the middle 40a, 40b, 40c, . . . 40n. The reflection is rich in visual effects instead of being a monotonous display. In addition, as shown in FIG. 9, the present invention not only has a wider area for displaying but also has two projecting sheets 17 arranged on both sides as projection windows for the shadows of the flowing glitters 44 to be projected thereon, combining with the lights being emitted and therefore displaying visual effects of moving shadows 442. The visual effects are different from the ones shown in FIG. 8; the lights and moving shadows 442 projected on the projecting sheets 17 are flickering, therefore making the present invention an artistic ornament of special visual effects.

With structures disclosed above, the present invention can not only display an unlimited extension of an inward serial arrangement of the transparent bottle 40 from the middle, but can further display a special visual effect of lighting and projection of the moving shadows 442 on both sides of the present invention, widening the visual angle and enriching the visual effects thereof.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A wide-angle lighting display and projection device comprising:
a frame including a base on which a front frame body and a rear frame body are arranged;
a film-coated glass mounted on the front frame body and having the front side with light transmittancy facing towards the front frame body as a window surface and the back side with reflectivity;
a mounting seat arranged on the base, between the front frame body and the rear frame body with a positioning hole arranged thereon;
a projecting device including at least one projecting light disposed in an engaging room under the positioning hole of the mounting seat with a projecting light source thereof aiming at the positioning hole;
a support bracket with the lower end thereof arranged on the base of the frame and a lighting source arranged on the upper end thereof;
a transparent bottle filled with a filler of liquids with the bottom thereof to be disposed on the positioning hole of the mounting seat and located above the projecting device, corresponding to the height of the window surface;
a first reflection mirror and a second reflection mirror fixed on the rear frame body, located behind the transparent bottle and having the reflection surfaces thereof facing forward, and a center thereof serving as a reference to define the first and second reflection mirrors symmetrically, inclined to form an angle θ between 145° and 175°, so that the window surface would display an unlimited extension of an inward serial arrangement of the transparent bottle from the middle after the contents thereof are reflected repeatedly and cumulatively by the first and second reflection mirrors;
a cover plate disposed on the rear frame body, behind the first and second reflection minors; and
two projecting sheets made of materials that are pervious to light but not transparent, and disposed on both sides of the frame for the transparent bottle to project thereon.

2. The wide-angle lighting display and projection device as claimed in claim 1, wherein the projecting device includes a PCB having at least one projecting lamp and one resistor arranged thereon with the projecting lamp including a LED light or a bulb.

3. The wide-angle lighting display and projection device as claimed in claim 2, wherein the base has a power supply disposed inside and connected to the projecting device to supply the electric power.

4. The wide-angle lighting display and projection device as claimed in claim 1, wherein the transparent bottle can be a lava lamp or a glitter lamp.

5. The wide-angle lighting display and projection device as claimed in claim 1, wherein the bottom of the transparent bottle has its periphery engaging with the positioning hole of the mounting seat by fitting or screwing, and the bottom periphery of the positioning hole has an inner flange thereon.

6. The wide-angle lighting display and projection device as claimed in claim 1, wherein the support bracket is arranged in an L shape and is hollow for the power supply to connect to an electric wire through which to supply the electric power for the lighting source on which a lampshade is covering.

7. The wide-angle lighting display and projection device as claimed in claim 1, wherein the first and second mirrors behind the rear frame body form an angle θ and have two symmetrical inclined surfaces to form a pre-determined slope when they are joined together.

8. The wide-angle lighting display and projection device as claimed in claim 1, wherein the two projecting sheets are disposed on the groove arranged between the front and rear frame body.

9. The wide-angle lighting display and projection device as claimed in claim 1, wherein the two projecting sheets are made of materials that are pervious to light but not transparent such as plastic board, paper, clothing, and glass.
